(19) United States
(12) Patent Application Publication
(10) Pub. No.: US 2015/0191337 A1
(43) Pub. Date: Jul. 9, 2015

(54) Method For Filling Bottles

(71) Applicant: The Central Bottling Company Ltd., Bnei-Brak (IL)

(72) Inventor: David MARON, Raanana (IL)

(21) Appl. No.: 14/662,556

(22) Filed: Mar. 19, 2015

Related U.S. Application Data
(63) Continuation-in-part of application No. PCT/IL2013/050770, filed on Sep. 11, 2013.

(30) Foreign Application Priority Data
Sep. 20, 2012 (IL) 222023

(51) Int. Cl. B67C 3/12; B67C 3/10; B67C 3/22

(52) U.S. Cl. CPC B67C 3/12; B67C 3/22; B67C 3/10

(57) ABSTRACT

A method of charging containers having flexible walls with a non-carbonated liquid, comprising: providing a non-carbonated liquid, dissolving a suitable gas in the non-carbonated liquid at a sub saturation level at a first temperature in a first temperature, transferring the non-carbonated liquid containing the dissolved gas into flexible walled containers to fill the containers to the top or to fill a pre-specified portion of the containers leaving an unfilled portion of the containers as a head space, closing the containers tightly, and allowing the non-carbonated liquid containing the dissolved gas to reach a second temperature whereby while maintaining a pressure in the head space to prevent deformation of the flexible walls during normal handling. The head space has a volume fraction that determines the required pressure of the dissolved gas in the non-carbonated liquid in order to produce a desired pressure build-up in the head space.

### CROSS-REFERENCE TO RELATED APPLICATIONS

This application is a continuation-in-part of International Application No. PCT/IL2013/050770, filed Sep. 11, 2013, which designates the United States and was published in English, and which claims priority of Israel Patent Application No. 222023, filed Sep. 20, 2012. The entire disclosures of each of the above applications are incorporated herein by reference.

### FIELD OF THE INVENTION

The present invention relates to a method for filling non-carbonated (or carbonated) beverages into thin-walled containers stabilized by internal pressure. More specifically, the present invention relates to dissolving gas in liquid to properly control the internal pressure of flexible or semi-flexible containers during and after processing.

### BACKGROUND OF THE INVENTION

Typical beverages can be in general classified into carbonated and noncarbonated classes of beverages. Traditional glass containers have been the mainstay for more than a century. However, the increasingly popular flexible or semi-flexible containers raise the attention to a proper control of the internal package pressure during and after processing.

Carbonated beverages, being oversaturated, require the flexible packaging to withstand the positive higher internal pressure compared to the external atmospheric pressure. Noncarbonated beverages, particularly when processed in hot filling, are associated with negative internal pressure compared to the surrounding pressure. The hot filling follows usually a thermal disinfection process, and thus, as the product is cooled (for instance, on the shelf), a negative pressure drop is developed, whereby the external pressure exerted on the packaging is higher than the internal pressure. To overcome the pressure difference, i.e., to increase the internal pressure to a level comparable with the external pressure, beverages and food industries have long utilized nitrogen gas for bottling and packaging applications.

In most related technologies, a micro-controlled drop of liquid nitrogen is injected into the container before it is capped and sealed. The basic idea behind most technologies is that when a small amount of liquid nitrogen hits the surface of the beverage or comes into the beverage core, it vaporizes and provides a pressure in the gas phase. In fact, and from the physical point of view, the cold liquid nitrogen (−190° C.), expands immediately into gaseous nitrogen as it is exposed to the environment (at room temperature). Probably, for hot fill process, the evaporation process of the small drop might be more rapid and dramatic. Therefore, pressure build-up by so-called gentle nitrogen spray, just before sealing, on top of the beverage just before capping, require an accurate charge of liquid nitrogen and a precisely timed drop of the liquid nitrogen into the head space of the container (bottle or can, etc.). Since the nitrogen injection is made individually per container, appropriate specialized installations are required to ensure a high purity precision of nitrogen dosing at various line speeds.

WO 99/02406 discloses a method of producing a liquid product packed in cans or bottles or other suitable containers. The method includes injecting one or more of nitrogen, carbon dioxide and nitrous oxide gas into the liquid product. One preferred feature of the method is to chill the liquid product prior to injecting gas. Another preferred feature is to add liquid nitrogen to the head spaces of filled containers before closing the containers.

US 2004/0035089 describes a method and installation for packaging a liquid product in thin-walled packages using an inert gas such as nitrogen and/or carbon dioxide, in the gaseous state that is introduced into the chilled liquid by means of an injector, the liquid becoming saturated or supersaturated with which gas(es).

GB 2134496 describes a method of filling cans with substantially non-carbonated drinks, in which method N₂ gas and CO₂ gas are dissolved as a mixture under pressure in the drink. Then, a predetermined quantity of the drink is introduced into the can at the same temperature and pressure at which the N₂ and CO₂ gases were dissolved in predetermined ratio in the drink and N₂ gas and/or a CO₂ containing inert gas is supplied over the surface of the drink in the can, substantially replacing the air in the head space in the can, while the can is open between the filling and sealing of the can.

GB 2241941 describes a method of charging containers, especially thin-walled cans, with a lowly-carbonated liquid such a beer comprises dissolving carbon dioxide in the liquid, and dissolving nitrogen in the liquid while circulating the solution through a chiller and thus the dissolution is carried out at a suitable sub-ambient temperature.

EP 0489589 describes a method for canning of a non-carbonated liquid food product according to which nitrogen is dissolved in the product at a temperature between 0 and 4° C. where the product is held under nitrogen pressure in a holding tank for a period of time sufficient to permit froth to subside. The filled cans are thereupon closed fluid-tight, and the nitrogen comes out of solution in each closed can to create a super atmospheric pressure therein.

As seen above, in all methods the liquid product is chilled prior to injecting gas, and in some methods, liquid nitrogen is added to the head spaces of filled containers before closing the containers. However, all relevant prior art references emphasize the need that a liquid has to be sufficiently oversaturated in order to ensure a sufficient amount of gas (nitrogen) in the product when sealed. As such, prior methods comprise injecting nitrogen few times the amount required to saturate the beverages, and/or including the step of chilling the liquid product to a predetermined temperature, and/or introducing a gas mixture of CO₂/N₂ in the product (with predetermined ratio), assuming that super saturated liquid in nitrogen is able to retain the nitrogen in excess of the saturation level over a prolonged period.

Moreover, in most prior methods, in addition to injecting nitrogen into the liquid, an additional gas N₂ and/or CO₂ is supplied over the surface of the product in the container while the container is still open between filling and sealing the container. This raised great difficulties of control and/or complicated synchronization.

It is worth noting at this point that the more saturated the liquid phase—the more dramatic and intensive is the gas escape. Besides, supersaturation is physically a less defined state and hence more difficult to control. As is shown herein, oversaturation is not necessarily needed in order to properly control the internal pressure of flexible or semi-flexible containers during and after processing.

Thus, an aim of the present invention is to provide a general method and comprehensive principles for pressure build-up and control in a cold or hot fill processes of carbonated or noncarbonated products. A method by which the exact amount of gas (or its corresponding pressure) required for a proper control of the final (shelf) internal pressure of flexible or semi-flexible containers is determined, and thus, prevents unnecessary oversaturation and gas waste.

Another aim of the present invention is to treat the complete line of production, or filler in accordance to the local pressure/temperature conditions rather than dealing with moving single containers. In contrast to gas-flush systems and to methods dispensing nitrogen drop for each bottle in separate. Thus, the proposed method is nitrogen gas saving and independent of line stoppage, line speed variation or any break time problems associated with other line equipment.

Last and not least, since the proposed method is associated with a well-defined physical state, it is easy to design and control.

### DETAILED DESCRIPTION OF THE INVENTION

One of the features of the present invention is to operate (the filling) with sub-saturated liquid and/or late saturation state so that the escape of the gas is not dramatic but of a minor effect.

The gas may be nitrogen, N₂, or any other gas such as air, N₂O, or CO₂ or any combination of these selected in accordance to the required pressure build-up, the product properties, filling conditions (e.g. filling temperature for instance), location of gas injection along the line, etc. For instance, carbon dioxide, CO₂, can be used for an internal pressure build-up to balance the external ambient pressure, P∞=1 atm. In this case, a very light carbonated water may be obtained. For T=25° C. and P=1 atm, the equilibrium solubility of CO₂ gas which may balance the ambient pressure is around 1.5 gr/l, far from regular carbonated beverages, but still not negligible and thus cannot be disregarded. However, after opening, the CO₂ concentration may decrease since the external CO₂ ambient concentration is ˜1%. Thus, the carbonation effect is practically of a very minor level and diminishes immediately after opening.

It is worth noting that health consideration between light carbonated or carbonated water relate mainly to the level of hydration. Some argue that carbonation may lead to the risk of dehydration (by developing pressure on the kidneys e.g.). On the other hand, researchers have identified some health benefits of light carbonated water. Indeed, the health difference between carbonated and noncarbonated drinks is still under intense debate.

Thus, utilizing CO₂, the low level of CO₂ used may bear a two-fold goal: (1) pressure build-up, and (2) light carbonated products at a desired level.

Another application for the method and principles presented above, is the use of nitrous oxide (laughing gas), N₂O, for pressure build-up and consequently for light gasification. Nitrous oxide is a non-toxic gas which is not flammable, has no color or odor, is slightly sweet and does not imitate. Therefore, it is widely used in the field of medicine, recreation, cooking and is licensed as food additive. The nitrous oxide gas is used in food services, e.g. cooking sprays, because it prevents the growth of bacteria, or it is filled in snack foods to displace the bacteria. It is also utilized as a foaming or mixing agent (in dairy processes for example, in making whipped cream, etc.).

Aside from being an important component of food production, e.g. nitrous-oxide cartridges are popular and are government approved food additives. It is also becoming a common alternative to carbon dioxide (cartridges) for cooling food products.

It is worth noting that nitrous oxide is considered to be a comparatively quite safer sedative even if inhaled accidentally. There is no “hangover” effect—the gas is eliminated from the body within 3-5 minutes after the gas supply is stopped. Nitrous oxide is not an allergen. Some side effects appear only if administered in very high doses and for a very long period in breathing. As such it is one of the popular source of entertainment and enjoyment. It is a real challenge nowadays for regulating the use of N₂O is to avoid shifting recreational use towards other intensive methods.

Another property of N₂O is that it is inert at room temperature and it dissolves in water to give neutral solution. The equilibrium that exists when nitrous oxide is dissolved in water lies far to the left:

N₂O+H₂O═H₂N₂O₂ (7)

In view of the above, utilizing nitrous oxide for pressure build-up (clearly not in breathing) and in relatively small concentrations (due to its high Henry constant, see below), may result in very moderate gasified products having a light characteristic of “happy drink”, absolutely safe (as you can drive home and don't need an escort), and can be produced with various controlled levels of gasification. Again, the aim of utilizing nitrous oxide is two-folds; first, for pressure build-up in practically very low concentration or for both pressure build-up and in happy light products in mild concentrations.

Utilizing micro/nano bubbles gasification:

Micro/nano bubbles are relatively of small rise velocity and are generated by various types of generators. In contrast to ordinary macro-bubbles which rise rapidly and burst at the interface, micro-bubbles remain suspended in the liquid for an extended period and dissolve in the liquid phase.

One of the most important features of micro/nano-bubbles is their high surface area to volume ratio which leads to high solubility in liquid and to an extremely stable late super-saturation solution.

In view of the above characteristics of micro/nano-bubbles, the gasification process (carbonation or nitrogenation) is carried out by utilizing micro/nano-bubbles. Compared to the scale-time of filling containers (cans and bottles) up to their complete sealing which is of the order of seconds or minutes, micro-bubbles may maintain late supersaturation due to their long life term before completely dissolved.

As a direct result, the gas volume (CO₂, N₂ or N₂O) is retained in the bubble and is released to the gas phase (head space) only after sealing the containers and after the product is cooled to the shelf temperature. Moreover, since gas is not released at the hot temperature, the initial pressure in the head space will not increase immediately after sealing the container (due to immediate intense gas escape as associated with oversaturation), but instead, the pressure in the head space will decline and gas will escape the liquid phase to compensate such decline only sometime after the product cools down.

### SUMMARY OF THE INVENTION

In accordance with the present invention, there is provided a method of filling flexible walled containers with liquid leaving a head space and maintaining the integrity of the flexible walls at a reduced temperature, comprising:
providing a filler unit having an access conduit and an exit conduit for passing liquid into the filler unit and dispensing it into the flexible walled containers;
introducing gas into said liquid at either a sub saturation or saturation level at an elevated temperature ranging from 80° C. to 90° C. either in the access conduit or in the filler unit, or in the exit conduit, or in any combination of these,
transferring the liquid containing the gas into flexible walled containers to fill a pre-specified portion of the containers leaving an unfilled portion of the containers as a head space;
closing the containers tightly;
allowing the liquid containing the gas to reach a lower temperature; whereby pressure formed by gas escaping from the liquid into the head space prevents deformation of the flexible walls during normal handling;
   wherein the amount of gas to be introduced into the liquid depends on the volume fraction of the headspace in the flexible walled container.

The present invention further comprises a method of filling flexible walled containers with liquid leaving a head space and maintaining the integrity of the flexible walls at a reduced temperature, comprising:
providing a filler unit having an access conduit and an exit conduit for passing liquid into the filler unit and dispensing it into the flexible walled containers;
introducing gas into said liquid at either a sub saturation or saturation level in the form of micro/nano-bubbles at an elevated temperature ranging from 80° C. to 90° C. either in the access conduit or in the filler unit or in the exit conduit, or in any combination of these,
transferring the liquid containing the micro/nano-bubbles into flexible walled containers leaving a pre-specified portion unfilled as a head space;
closing the containers tightly; and
allowing the liquid containing the micro/nano-bubbles to reach a lower temperature whereby pressure formed by gas escaping from the liquid into the head space prevents deformation of the flexible walls during normal handling;
   wherein the amount of gas to be introduced into the liquid depends on the volume fraction of the headspace in the flexible walled container.

The present invention further comprises a method of filling flexible walled containers with liquid leaving a head space and maintaining the integrity of the flexible walls at a reduced temperature, comprising:
providing a filler unit having an access conduit and an exit conduit for passing liquid into the filler unit and dispensing it into the flexible walled containers;
passing liquid through a buffer tank and filtering system; and
pasteurizing the liquid before introducing it into the filler unit prior to entering the access conduit;
introducing gas into said liquid optionally in the form of micro/nano-bubbles at either a sub saturation or saturation level at an elevated temperature ranging from 80° C. to 90° C. either in the access conduit or in the filler unit, or in the exit conduit, or in any combination of these,
transferring the liquid containing the gas from the filler unit into flexible walled containers to fill a pre-specified portion of the containers leaving an unfilled portion of the containers as a head space;
closing the containers tightly.

Furthermore, in accordance with the present invention, the above method further comprises introducing gas into said liquid by means of at least one gasification unit, said gasification unit comprising an annular microporous element that controls the size of the produced bubbles.

Furthermore, in accordance with the present invention, the above method further comprises introducing gas into said liquid by means of at least one gasification unit, said at least one gasification unit comprising an annular microporous element that controls the size of the produced bubbles, and wherein multiple gasification units are positioned successively.

Furthermore, in accordance with the present invention, the above method further comprises introducing gas into said liquid by means of at least one gasification unit, said at least one gasification unit comprising an annular microporous element that controls the size of the produced bubbles, wherein multiple gasification units are positioned successively, and wherein pressure of the gas entering a first gasification unit and the annular microporous element of the first gasification unit produce bubbles that are different in size from the bubbles produced by an annular microporous element of a second gasification unit into which gas enters at a different pressure.

Furthermore, in accordance with the present invention, the gas is an inert gas.

Furthermore, in accordance with the present invention, the gas is selected from air, N₂, N₂O, CO₂, or any combination of these.

Furthermore, in accordance with the present invention, the gas provides pressure build-up and/or gasifies the liquid.

Furthermore, in accordance with the present invention, the liquid comprises more than one component.

Furthermore, in accordance with the present invention, the pasteurization is carried out at an elevated temperature ranging from 80° C. to 90° C.

Furthermore, in accordance with the present invention, the pressure of the liquid after introducing gas in the access conduit and/or filler unit and/or exit conduit ranges from 1 to 10 bars.

Furthermore, in accordance with the present invention, the method further comprises raising the pressure of the liquid by pumping the liquid prior to its entry into the filler unit.

Furthermore, in accordance with the present invention, the flexible walled containers are open to the atmosphere during filling.

Furthermore, in accordance with the present invention, the containers are closed to the atmosphere during filling.

Furthermore, in accordance with the present invention, the containers are provided at or below ambient temperature during and after filling.

### BRIEF DESCRIPTION OF THE FIGURES

FIG. 1 is a schematic illustration of a process for pressure build-up and control in a hot or cold-fill line of non-carbonated products;

FIG. 2 is a schematic illustration of a process identical to the process illustrated in FIG. 1 aside for an additional pump.

FIGS. 3 and 4 elaborate the principles of sub-saturation operations.

FIG. 5 illustrates a GS unit used in the processes shown in FIGS. 1 and 2.

FIG. 6 illustrates multiple GS units positioned successively along the product line.

FIGS. 7 and 8 demonstrate more specifically the entrance points of the micro/nano bubbles in the processes for pressure build-up and control shown in FIGS. 1 and 2.

Corresponding reference numerals indicate corresponding parts throughout the several views of the drawings.

### DETAILED DESCRIPTION OF THE FIGURES

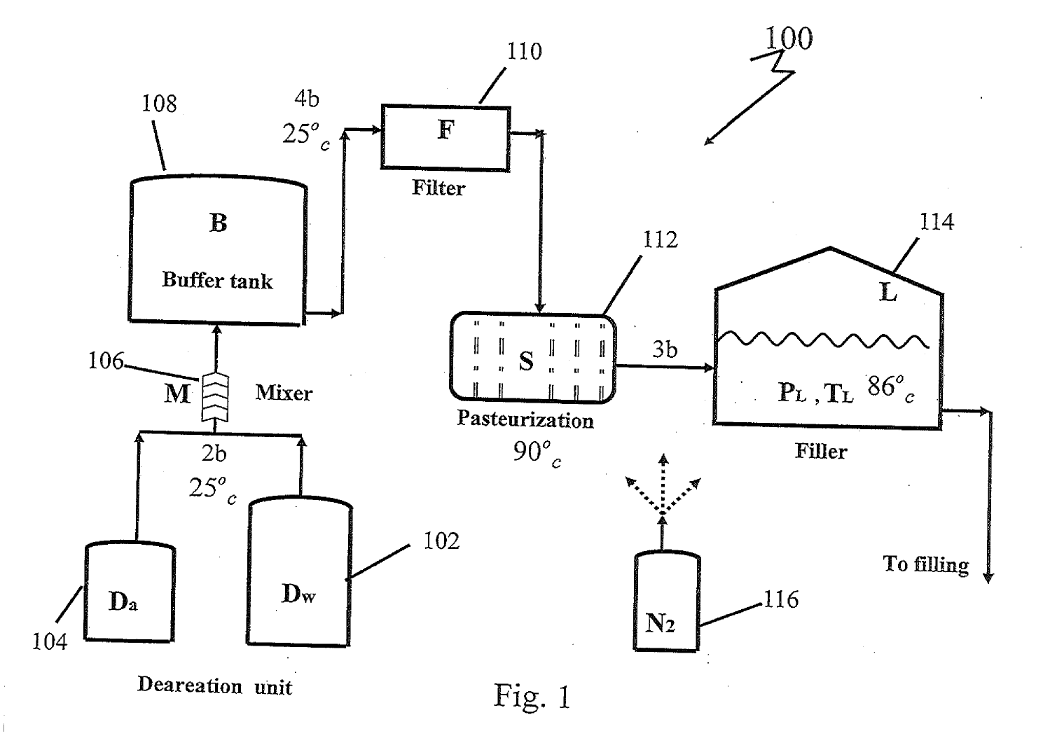

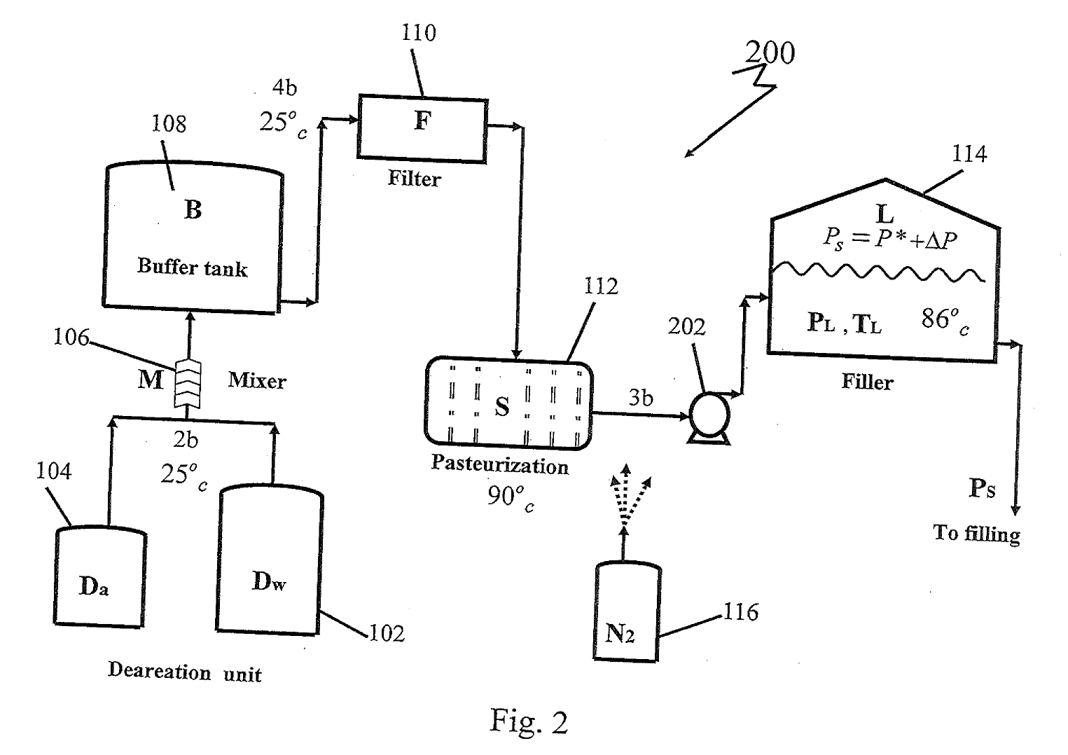

The processes illustrated in FIGS. 1 and 2 enable maintaining a sub-saturation level throughout the entire hot or cold-fill line of non-carbonated products in accordance with the present invention. The general case of varying temperature along the line is elaborated below.

Referring now to FIG. 1 which is a schematic illustration of a process 100 for pressure build-up and control in a hot-fill line of non-carbonated products.

As seen in FIG. 1, water 102 and component A 104 are mixed in mixer unit 106. The well mixed product is then passed through a buffer tank 108 to a filtering system 110. The temperature so far remains practically unchanged (around 25° C.).

Pasteurization by heat takes place at the thermal unit 112, wherefrom the product is transferred to and maintained in the filler unit 114, at a temperature, T_{L}, ranging from 86° C. to 90° C.

Gas Nitrogen 116, from a Nitrogen source N₂ (or any other gases as noted above), is fed into the feed line to the filler unit 114, at pressure Pᵢ>P_{L}, where P_{L} is the pressure at the filler unit 114. The pressure, P_{L}, is maintained at its required (design) value, by the aid of the Nitrogen 116. It should be noted, however, that Nitrogen can be injected anywhere along the line.

Generally, in practice the pressure along the line is roughly about 4 bars. However, due to pressure drop along the line, the pressure at the entrance of the filler unit 114 is somewhat lower, i.e., about 2-3 bars.

From the filler unit 114, the product is fed into the containers which are usually kept at a surrounding temperature of 25° C.

FIG. 2 is a schematic illustration of a process 200 which is identical to process 100 in most parts aside for pump 202 which is additional to process 200. Pump 202 raises the pressure of the product prior to its entry to filler 114.

Process 100 is of a typical line, whereby the pressure is highest at the entry and decreases along the line, whereas process 200 includes a pressure rise downstream due to pumping of the product to the filler unit 114. Thus, process 100 is characterized by low pressure at the filler unit 114 while in process 200 the pressure at the filler unit 114 is higher than that of the upstream. These two processes are further analyzed bellow with regard to maintaining a sub-saturation level throughout the entire line.

In both process 100 and process 200, the product in the filler unit 114 may be in equilibrium or under-saturation corresponding to the pressure P_{L} and temperature T_{L} (86° C., for instance). From the filler unit 114, the product is fed into the containers which are usually at the surrounding temperature of 25° C. The containers may be either close or open at the filling process.

The physical situations along the line are now illustrated with respect to the nitrogen. Based on the value of the Henry's law constant at T_{L}=86° C. for Nitrogen in water, the solubility at the filler unit 114 can be calculated as follows:

P=H(T)×C (1)

For illustration, the variation of Henry constant (coefficient) with temperature is estimated by the so-called Van′t Hoff relation, whereby;

$$H ( T ) = H ( {T}_{0} ) exp [ - {C}_{i} ( \frac{1}{T} - \frac{1}{{T}_{0}} ) ] \qquad ( 2 a )$$

For Nitrogen, the corresponding values for C, and H(Tₒ) are;

Cᵢ=800 (2b)

and

Tₒ=298.15° K;H(Tₒ)=1639.34 (2c)

An analysis of the physical situation at the filling point for two cases of open and closed containers is presented as follows:

Table 1 presents typical calculated values of pressure build-up as function of the filler pressure, P_{L}, in a single phase (liquid) closed system.

| Filler | C_{L} * (P_{L}, | | | | | | |
|---|---|---|---|---|---|---|---|
| pressure | T_{L} = 86° C.) | | | | | | |
| P_{L} atm | gr/liter | P * (25° C.) | Δ ps | P * (15° C.) | Δ Cs | Δ Cr1 | Δ Cr2 |
| 2 | 0.022 | 1.25 | 0.25 | 1.16 | 0.011 | 2 | 1.29 |
| 2.5 | 0.027 | 1.6 | 0.6 | 1.44 | 0.016 | 2.4 | 1.59 |
| 3 | 0.032 | 1.9 | 0.9 | 1.73 | 0.021 | 2.9 | 1.88 |
| 3.5 | 0.038 | 2.2 | 1.2 | 2.02 | 0.027 | 3.4 | 2.23 |
| 4 | 0.043 | 2.54 | 1.54 | 2.3 | 0.032 | 3.9 | 2.53 |

For the present demonstration in Table 1, a constant temperature of T_{L}=86° C. corresponding to a hot fill process is used. CL* denotes the equilibrium solubility at (P_{L}, T_{L}), based on the Henry-constant at T_{L}.

The filler pressure, P_{L}, is varying from 2.0 to 2.5, 3.0, 3.5 and 4.0. For each value of P_{L}, the corresponding concentration CL* is calculated and used for calculating the resulting pressure at 25° C. However, according to the values of P*(25) in table 1, one can operate at subsaturation level to yield P*(25)=1.0 atm.

Thus, assuming (at first), that the filling process is fast enough, hence there is no nitrogen loss prior to sealing, then, the new equilibrium pressure at various temperatures is predicted. For instance, at a common shelf temperature of 25° C., the corresponding pressure P*(25° C.) is always higher than atmospheric pressure, when the design filler pressure is P_{L}>2 atm. As the product cools to 15° C. (for instance before use), the internal pressure P*(15° C.) is still sufficient to resist the external ambient pressure, P∞=1 atm.

Also included in Table 1, is the super-saturation at the shelf temperature, T=25° C., defined in terms of pressure difference as;

Δps=p*(25° C.)−P∞ (3)

Note that, Δps stands for pressure difference above the ambient pressure, and it represents the driving force for the gas to escape. Since p*(25° C.) is the equilibrium pressure at the container walls T_{L}=25° C. As seen in Table 1, Δps is relatively low, sustaining the assumption of minor gas loss.

Another parameter ΔCs can be defined in terms of the solubility difference as;

ΔCs=C*(P_{L},86° C.)−C*(P∞,86° C.) (4)

where C*(P_{L}, 86° C.) is the solubility at the filling temperature and filler pressure, P_{L} and C*(P∞, 86° C.) is the solubility at the filling temperature and container pressure, P∞=1 atm. Thus, C*(1, 86° C.)=0.011 gr/I by eq (1).

The parameter Δ Cs represents the intensity or the physical driving force that liquid will reject the dissolved gas while filling. However, since the container walls are practically at 25° C. during the filling process, this intensity can be related to C*(1 atm, 25° C.)=0.017 gr/I rather than to C*(1 atm, 86° C.)=0.011 gr/l. Included in Table 1 are the ratios ΔCr₁ and ΔCr₂, which are the ratio of the equilibrium concentration at the filler, C*(P_{L}, 86° C.) to either C*(1 atm, 86° C.) or C*(1 atm, 25° C.), respectively;

ΔCr₁=C*(P_{L},86° C.)/C*(1,86° C.) (5)

ΔCr₂=C*(P_{L},86° C.)/C*(1,25° C.) (6)

Clearly, ΔCr2<ΔCr1 implies that gas nucleation which usually may initiate at the walls but is rather moderate, sustaining the assumption that the gas loss during the relatively short time filling is practically minor. As such, filling containers of relatively cold walls are preferable from the point of view of holding the nitrogen in the bulk product.

Note that the analyses so far relate to the liquid phase alone; this is consistent with the assumption that the gas escape is minor. However, simultaneous two-phase modeling of the gas-liquid interaction can be carried out, if the head space volume is known. A rather more complicated calculation procedure yields whereby, the distribution of the nitrogen gas in both the liquid and gas phases. Such calculation procedure, which includes mathematical modeling as well as empirical solutions, reveals the dramatic effects of the head space in various filling conditions as indicated in tables 2-4.

Tables 2-4 represent typical results for a variety of possible operations in two-phase systems where:

Pₒ denotes the initial partial pressure of nitrogen at the head space at filling,
V_{G}/V_{L} is the head space fraction,
P₂ is the design required pressure at temperature T₂(=25° C. for the purpose of illustration), and
P₁ is the required filler pressure at temperature T₁(=86° C. for the purpose of illustration), which is required to yield the desired pressure P₂.
Table 2 presents calculated values for various head space ratios in a two-phase open system where the head space is initially occupied by nitrogen P₀₌1.0 atm).

| | | | P2 | | P1t | P1 | P3 | C2* |
|---|---|---|---|---|---|---|---|---|
| P₀ | | T₂ | at | T1 | at | at | at | at |
| atm | VG/VL % | 25° C. | 25° C. | 86° C. | 86° C. | 86° C. | 10° C. | 25° C. |
| 1.00 | 5 | 25 | 1.25 | 86 | 1.58 | 4.05 | 1.16 | 0.021 g/l |
| 1.00 | 3 | 25 | 1.25 | 86 | 1.62 | 3.20 | 1.15 | 0.021 |
| 1.00 | 2 | 25 | 1.25 | 86 | 1.66 | 2.77 | 1.14 | 0.021 |
| 1.00 | 1 | 25 | 1.25 | 86 | 1.73 | 2.34 | .131 | 0.021 |
| 1.00 | 3 | 25 | 1.10 | 86 | 1.43 | 2.51 | 1.02 | 0.019 |

Table 3 presents calculated values for various head space ratios in a two-phase open system where the head space is initially occupied by air (P₀=O.79N2).

| | | | P2 | | P1t | P1 | P3 | C2* |
|---|---|---|---|---|---|---|---|---|
| P₀ | | T2 | at | T1 | at | at | at | at |
| atm | V_{G}/V_{L} % | 25° C. | 25° C. | 86° C. | 86° C. | 86° C. | 10° C. | 25° C. |
| 0.79 | 5 | 25 | 1.25 | 86 | 1.58 | 4.93 | .161 | 0.021 |
| 0.79 | 3 | 25 | 1.25 | 86 | 1.62 | 3.73 | .151 | 0.021 |
| 0.79 | 2 | 25 | 1.25 | 86 | 1.66 | 3.12 | .141 | 0.021 |
| 0.79 | 1 | 25 | 1.25 | 86 | 1.73 | 2.52 | 1.13 | 0.021 |
| 0.79 | 3 | 25 | 1.10 | 86 | 1.43 | 3.04 | 1.02 | 0.019 |

As the filling process comes to an end, the new equilibrium pressure, immediately after sealing, is denoted by Pit. As the temperature decreases to T₂=25° C. or T₃=10° C., the corresponding pressures are P₂ and P₃. Included in the tables are also the concentration C₂*(25° C.).

In principle, accounting for a given head space volume, a higher filler pressure is required to ensure the final P*(25° C.). For instance, as shown in Table 1, in order to end up with gas pressure of P(25° C.)=1.25 atm in a single phase (liquid) system, the required filler pressure is 2 atm. However, as shown in Table 2, in a two phase (liquid/gas) system, assuming the head space is 3%, the required filler pressure at 86° C. is 3.2 atm. If the head space volume is about 2% of the total container volume, the required filler pressure decreases to 2.77 atm. Clearly, if the required final pressure is lower for instance, if P₂ (25° C.) is only 1.1 atm, the filler pressure will be only 2.51 atm for head space fraction of 3%_{.}

Seen in Table 3, as open container initially occupied with air (0.79N₂), the required filler pressure also increases, i.e., the required filler pressure for a 3% head space is 3.73 atm and 3.12 atm for 2% head space, compared to 3.2 and 2.77 atm respectively, when the head space is initially filled with pure nitrogen as in Table 2.

Another mode of interest is presented in Table 4, which refers to a closed system rather than open systems as presented in tables 2 and 3.

Table 4 presents calculated values of pressure in the liquid phase in a two-phase closed system.

| P₀ = Psat (atm) | | | P2 | | P1t | P1 | P3 | C2* |
|---|---|---|---|---|---|---|---|---|
| Closed-bottle | | T2 | at | T1 | at | at | at | at |
| filling | VG/VL % | 25° C. | 25° C. | 86° C. | 86° C. | 86° C. | 10° C. | 25° C. |
| 1.58 | 5 | 25 | 1.25 | 86 | 1.58 | 1.58 | .161 | 0.021 |
| 1.62 | 3 | 25 | 1.25 | 86 | 1.62 | 1.62 | .151 | 0.021 |
| 1.66 | 2 | 25 | 1.25 | 86 | 1.66 | 1.66 | .141 | 0.021 |
| 1.73 | 1 | 25 | 1.25 | 86 | 1.73 | 1.73 | 1.13 | 0.021 |
| 1.43 | 3 | 25 | 1.10 | 86 | 1.43 | 1.43 | 1.02 | 0.019 |

In this case, the filling process is carried out by a counter pressure identical to the filler pressure. In fact, the containers are practically closed during the filling process and the initial pressure in the containers is the filler pressure. This mode of filling is generally used in carbonated products.

A comparison between the parameters of Table 4 with the corresponding parameters of Tables 2 and 3 indicates that the required filler pressures are much lower in the case of filling closed containers with counter pressure.

It should be noted that in hot fillings, the vapor pressure of the liquid (water) is significant. For instance, at 86° C. the vapor pressure is nearly 0.6 atm. Therefore, the partial pressure of the gas (of Nitrogen, for instance) just above the liquid interface is about 0.4 atm. An initial partial pressure of 0.4 atm instead of 1 or 0.79 atm yields higher P1 values than those in tables 2 and 3. Some typical values for comparison are shown in Table 5. Inspection of Tables 2, 3, and 5 indicates that it is of high importance to reduce the head space as much as possible particularly in hot fill processes.

Table 5 presents calculated values for various head space ratios in a two-phase open system where the head space is initially occupied by nitrogen and vapor.

| P₀ | | T2 | P2 | T1 | P1t | P1 |
|---|---|---|---|---|---|---|
| atm | VG/VL % | 25° C. | at 25° C. | 86° C. | at 86° C. | at 86° C. |
| 0.4 | 3 | 25 | 1.25 | 86 | 1.62 | 4.71 |
| 0.4 | 2 | 25 | 1.25 | 86 | 1.66 | 3.78 |
| 0.4 | 1 | 25 | 1.25 | 86 | 1.73 | 2.85 |
| 0.4 | 3 | 25 | 1.04 | 86 | 1.43 | 3.73 |

It should be further noted that the illustrations so far relate to a filling temperature of T_{L}=86° C. Clearly, a filling temperature that is lower than 86° C. requires a lower pressure, P_{L} or P₁, to provide a shelf pressure of 1.25 atm (at 25° C.).

In addition, it should be noted that the gas may be injected at any point along the line. For illustration of the effects of the location of gas injection, table 6 includes various situations of pressure and temperature along the filling line, while pointing out in each case the minimal gas concentration to be used so that a sub-saturation is ensured through the whole line.

Table 6 presents data corresponding to injection of the gas along various locations of the filling line.

| | | H_{N2} | | | |
|---|---|---|---|---|---|
| | | atm · lit/gm | | | |
| | | 1639.3 | 2173.2 | 2585.8 | 1639.3 |
| | | T (° C.) = | | | |
| Exp No. | | 25 | 60 | 86 | 25 |
| 1 | Pₐₜₘ | 1 | 1 | 1 | 0.63 |
| | C = gr/l | 0.017 | 0.013 | Cm = 0.011 | 0.011 |
| 2 | P | 1 | 2 | 2 | 1.06 |
| | C | 0.017 | 0.026 | 0.022 | Cm = 0.018 |
| 3 | P | 1.24 | 2 | 2 | 1.24 |
| | C | 0.021 | 0.026 | 0.022 | Cm = 0.021 |
| 4 | P | 3-4 | 3.5 | 2.5 | 1.6 |
| | C | 0.051-0.068 | 0.045 | Cm = 0.027 | 0.027 |
| 5 | P | 3-4 | 3.5 | 2.75 | 1.74 |
| | C | 0.051-0.068 | 0.045 | 0.030 | 0.030 |

As seen in Table 6, for a constant pressure along the line as in Exp. No. 1, the minimal solubility Cₘ is obviously at the high temperature of 86° C. In order to prevent foaming along the line, the gas should be injected at a point along the line in which the solubility is minimal.

For instance, if the pressure is roughly 1 atm along the line, then Cₘ=0.011 gr/I or corresponds to the highest temperature along the line (e.g., 86° C.) which may produce an internal pressure of only 0.63 atm at 25° C. (see Exp. No. 1). On the other hand, if the pressure along the line is 2 atm. (Exp. No. 2) then the minimal solubility Cm=0.022 gr/I which is higher than the solubility of 0.017 gr/l, required to produce an internal pressure of 1 atm at 25° C. Thus, if Cm=0.022 gr/I is injected at the high temperature, then an internal pressure of 1.27 atm is produced at 25° C., and an injection of 0.018 gr/I yields an internal pressure of 1 atm. Alternatively, Cm=0.021 gr/1 can be injected at 25° C. before the pasteurization phase) but with pressure of 1.24 atm, ensuring that no foams develop at 86° C. and 2 atm (Exp. No. 3). Experiments Nos. 4-5 in Table 6, represent the general case of both pressure and temperature variations along the line. When the minimal concentration is injected, sub-saturation is ensured along the line while a sufficiently positive internal pressure at the shelf-temperature (25° C.) still prevails.

It should be noted that the method and principles discussed above in relation to the schematic flow chart of FIGS. 1 and 2 can in fact be applied as well to any process for providing an internal pressure build-up as required.

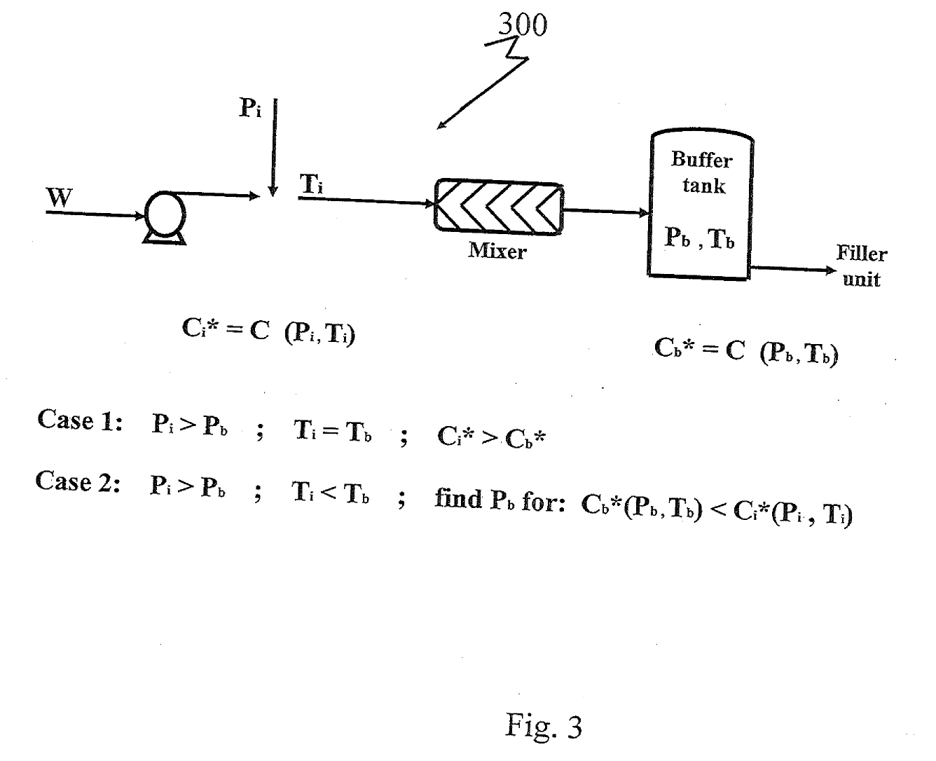

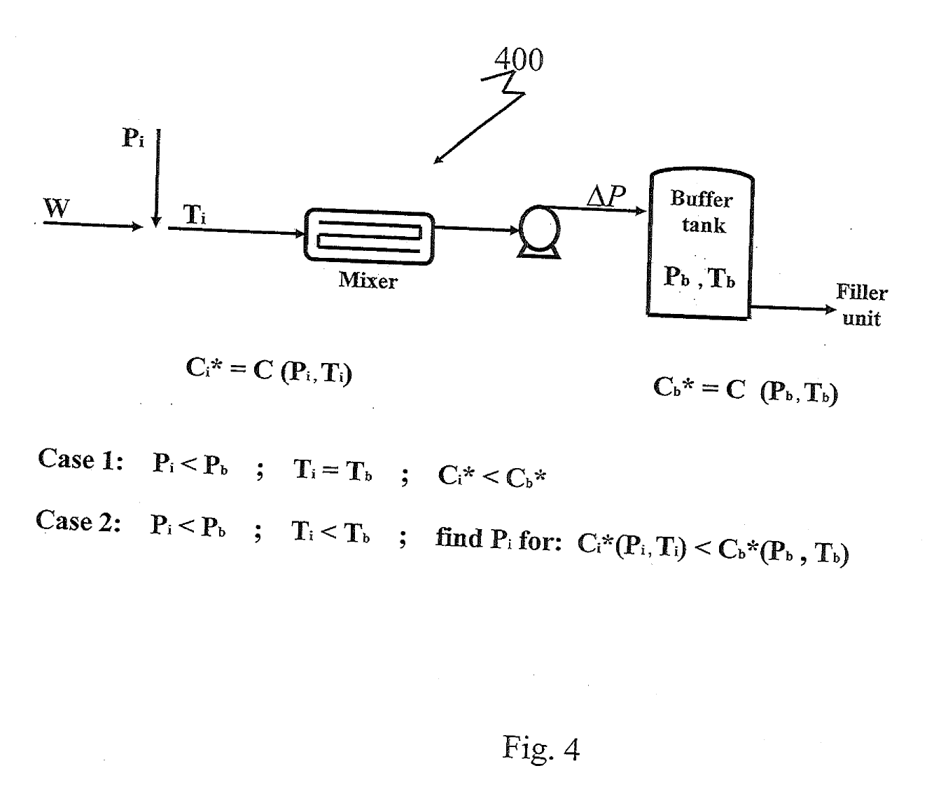

The principle of sub-saturation operation is further elaborated in FIGS. 3 and 4. In mode A of FIG. 3, the pressure monotonously decreases towards the filler. In mode B of FIG. 4, on the other hand, the filling is carried out after raising the pressure to easily-controlled differential ΔP, such that filler pressure is at P_{b}=P*+ΔP. Thus, in mode A, the lower concentration Cb(<Ci) is injected at the high pressure zone upstream, point I, while in mode B, the filler pressure/temperature conditions are known, and the upstream pressure at injection is evaluated, so that Ci<Cb. Again, in both modes sub-saturation states are ensured.

Beyond that, if micro/nano bubbles are used, late saturation or even oversaturation can be maintained for retaining the gas in the liquid bulk before approaching the gas-liquid interface.

It should be noted that the gas in the form of micro/nano-bubbles can be injected into the liquid prior to entering to the filler, while in the filler, or after exiting the filler just before filling the containers.

Typical micro/nano bubble generators, such as those described in U.S. Pat. No. 7,628,912 and U.S. Pat. No. 8,186,653, pressurize a mixture of liquid and gas in a given tank, then the liquid saturated with gas is flashed into a liquid phase, whereby the size and density of the tiny bubbles depend on the final pressure, i.e., after flashing.

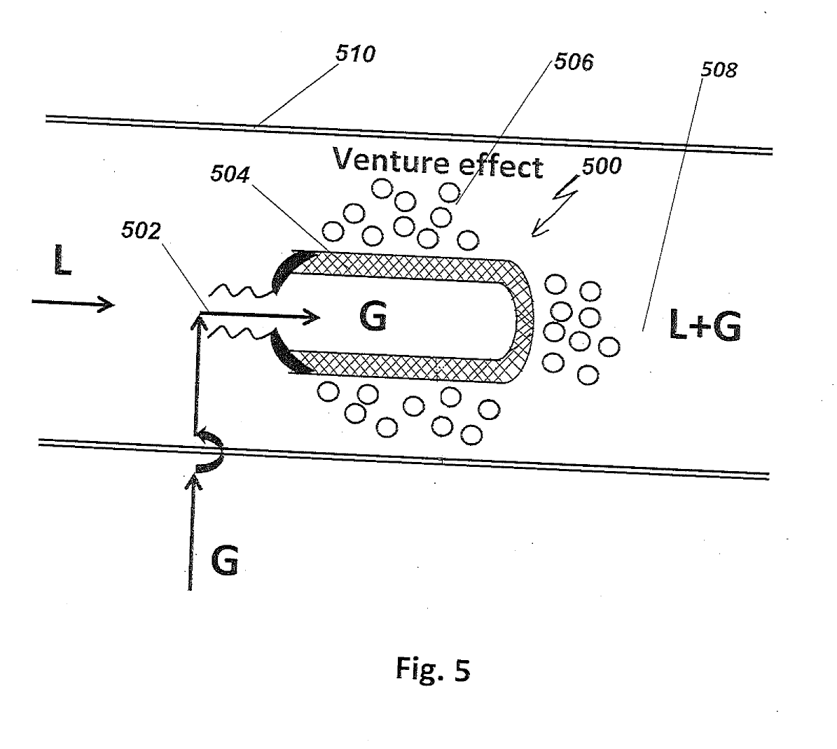

In the present application, however, in order to avoid the use of a rather complicated external generator and its associated elements for the production of micro/nano bubbles, it is proposed to utilize the so-called “gasification station” (GS) unit, which is a micro/nano bubble diffuser such as those manufactured by Pall Corporation and shown in FIG. 5.

FIG. 5 illustrates a GS unit 500 used in the processes shown in FIGS. 1 & 2.

The GS unit 500 includes an annular opening 502 and an annular microporous element 504 made of ceramic, stainless steel, teflon and the like which may be aimed at diffusing tiny bubbles at any point along the process line.

The GS unit may be located anywhere along the process line, is easy to install, and simply controls the bubble size and density (parameters which are essential in the process under consideration). Gas enters through opening 502 and leaves the GS unit 500 through the annular microporous element 504 as tiny bubbles directly into the product line.

The size of the bubbles is well controlled by the gas pressure and pores size of annular microporous element 504 of the GS unit 500. Due to the high cross velocity and thus the venture effect at the annular zone 506, bubbles are detached at a relatively small size.

The pressure recovery downstream from the GS unit 500, i.e., in zone 508, enhances the collapse of bubbles in the liquid.

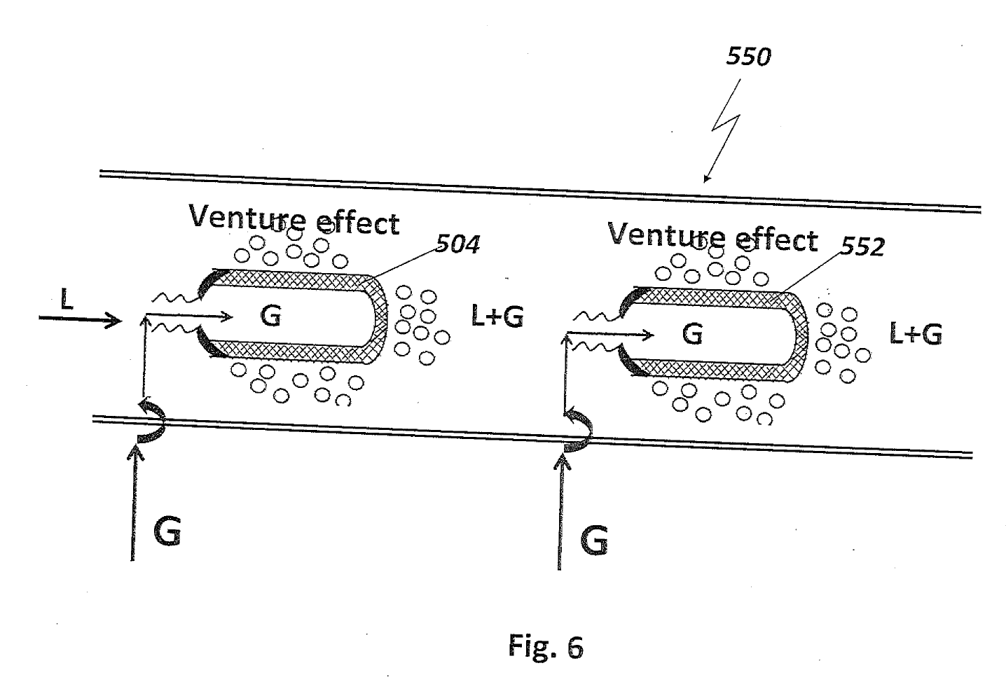

Based on the required gas saturation level, multiple GS units 550 may be positioned successively along the product line as seen, for instance, in FIG. 6.

It should be noted that the pressure of the gas entering one GS unit and the pores size of the annular microporous element of that GS unit may be different from the pressure of the gas entering a second GS unit and the pores size of the annular microporous element of the second GS units in order to better control the saturation level.

From the clean in place (CIP) point of view, the use of a GS unit is advantageous since it does not require careful sanitation processes as does an external micro/nano-bubble generator.

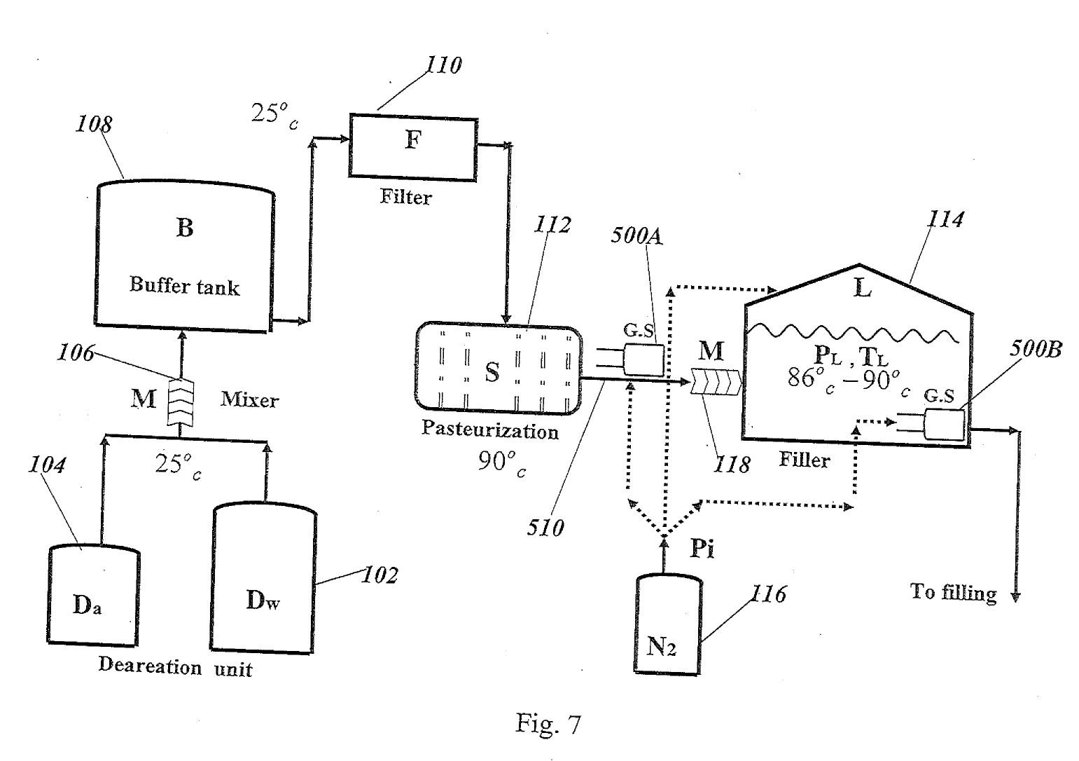

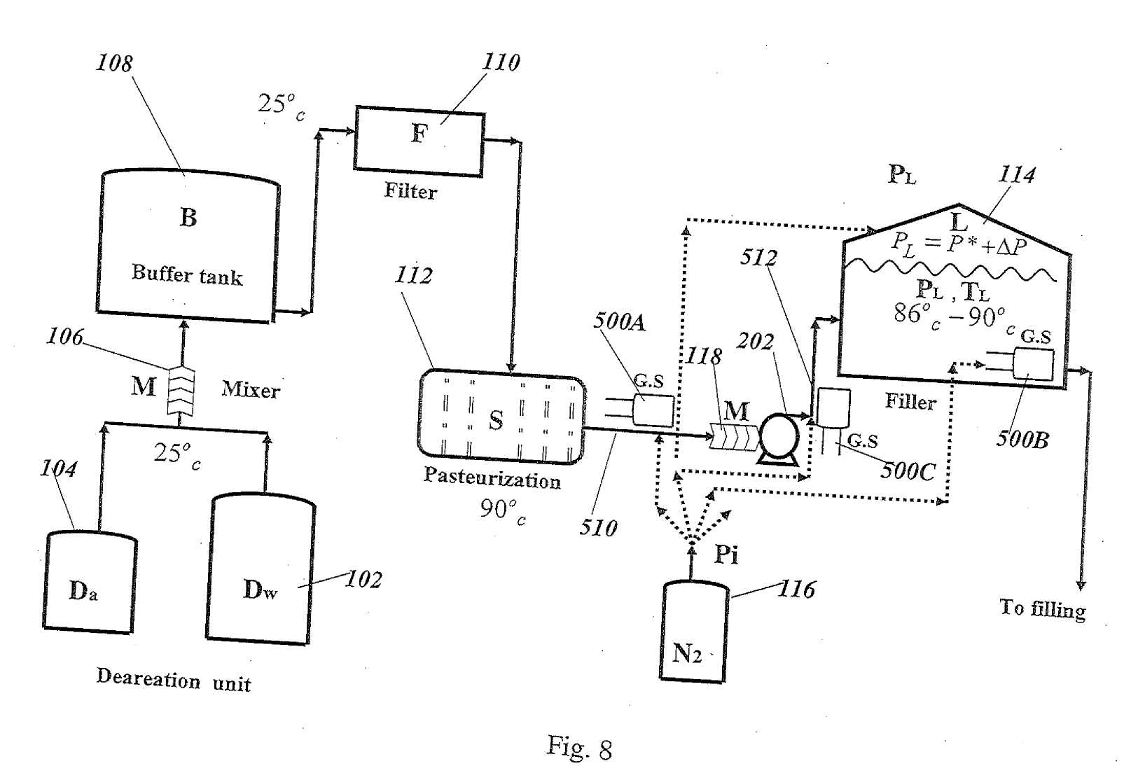

FIGS. 7 & 8 demonstrate more specifically the entrance points of the micro/nano-bubbles in the processes shown in FIGS. 1 & 2. As seen in FIGS. 7 & 8, GS unit 500A diffuses tiny bubbles into the feed line 510 prior to the entrance to the filler unit 114, and GS unit 500B diffuses tiny bubbles into the filler unit 114 close to the exit of the product from the filler unit 114. In FIG. 8 there is shown an additional GS unit 500C which may be installed after the pump 202 in line 512 and thus may diffuse tiny bubbles into the pressurized feed line exiting the pump 202.

What is claimed is:

1. A method of filling flexible walled containers with liquid leaving a head space and maintaining the integrity of the flexible walls at a reduced temperature, comprising:
providing a filler unit having an access conduit and an exit conduit for passing liquid into the filler unit and dispensing it into the flexible walled containers;
introducing gas into said liquid at either a sub saturation or saturation level at an elevated temperature ranging from 80° C. to 90° C. either in the access conduit or in the filler unit, or in the exit conduit, or in any combination of these,
transferring the liquid containing the gas into flexible walled containers to fill a pre-specified portion of the containers leaving an unfilled portion of the containers as a head space;
closing the containers tightly;
allowing the liquid containing the gas to reach a lower temperature; whereby pressure formed by gas escaping from the liquid into the head space prevents deformation of the flexible walls during normal handling;
wherein the amount of gas to be introduced into the liquid depends on the volume fraction of the headspace in the flexible walled container.

2. The method according to claim 1, wherein said gas is an inert gas selected from air, N₂, N₂O, CO₂, or any combination of these.

3. The method according to claim 1, wherein said gas provides pressure build-up and/or gasifies the liquid.

4. The method according to claim 1, wherein the pressure of the liquid after introducing gas in the access conduit and/or filler unit and/or exit conduit ranges from 1 to 10 bars.

5. The method according to claim 1, further comprising raising the pressure of the liquid by pumping the liquid prior to its entry into the filler unit.

6. The method according to claim 1, wherein the flexible walled containers are either open or closed to the atmosphere during filling.

7. The method according to claim 1, wherein the containers are provided at or below ambient temperature during and after filling.

8. A method of filling flexible walled containers with liquid leaving a head space and maintaining the integrity of the flexible walls at a reduced temperature, comprising:
providing a filler unit having an access conduit and an exit conduit for passing liquid into the filler unit and dispensing it into the flexible walled containers;
introducing gas into said liquid at either a sub saturation or saturation level in the form of micro/nano-bubbles at an elevated temperature ranging from 80° C. to 90° C. either in the access conduit or in the filler unit or in the exit conduit, or in any combination of these,
transferring the liquid containing the micro/nano-bubbles into flexible walled containers leaving a pre-specified portion unfilled as a head space;
closing the containers tightly; and
allowing the liquid containing the micro/nano-bubbles to reach a lower temperature whereby pressure formed by gas escaping from the liquid into the head space prevents deformation of the flexible walls during normal handling;
wherein the amount of gas to be introduced into the liquid depends on the volume fraction of the headspace in the flexible walled container.

9. The method according to claim 8, further comprising introducing gas into said liquid by means of at least one gasification unit, said gasification unit comprising an annular microporous element that controls the size of the produced bubbles.

10. The method according to claim 8, further comprising introducing gas into said liquid by means of at least one gasification unit, said at least one gasification unit comprising an annular microporous element that controls the size of the produced bubbles, and wherein multiple gasification units are positioned successively.

11. The method according to claim 8, further comprising introducing gas into said liquid by means of at least one gasification unit, said at least one gasification unit comprising an annular microporous element that controls the size of the produced bubbles, wherein multiple gasification units are positioned successively, and wherein pressure of the gas entering a first gasification unit and the annular microporous element of the first gasification unit produce bubbles that are different in size from the bubbles produced by an annular microporous element of a second gasification unit into which gas enters at a different pressure.

12. The method according to claim 8, wherein said gas is an inert gas selected from air, N₂, N₂O, CO₂, or any combination of these.

13. The method according to claim 8, wherein said gas provides pressure build-up and/or gasifies the liquid.

14. The method according to claim 8, wherein the pressure of the liquid after introducing gas in the access conduit and/or filler unit and/or exit conduit ranges from 1 to 10 bars.

15. The method according to claim 8, further comprising raising the pressure of the liquid by pumping the liquid prior to its entry into the filler unit.

16. The method according to claim 8, wherein the flexible walled containers are either open or closed to the atmosphere during filling.

17. The method according to claim 8, wherein the containers are provided at or below ambient temperature during and after filling.

18. A method of filling flexible walled containers with liquid leaving a head space and maintaining the integrity of the flexible walls at a reduced temperature, comprising:
providing a filler unit having an access conduit and an exit conduit for passing liquid into the filler unit and dispensing it into the flexible walled containers;
passing liquid through a buffer tank and filtering system; and
pasteurizing the liquid before introducing it into the filler unit prior to entering the access conduit;
introducing gas into said liquid optionally in the form of micro/nano-bubbles at either a sub saturation or saturation level at an elevated temperature ranging from 80° C. to 90° C. either in the access conduit or in the filler unit, or in the exit conduit, or in any combination of these,
transferring the liquid containing the gas from the filler unit into flexible walled containers to fill a pre-specified portion of the containers leaving an unfilled portion of the containers as a head space;
closing the containers tightly;

19. The method according to claim 18, further comprising introducing gas into said liquid by means of at least one gasification unit, said gasification unit comprising an annular microporous element that controls the size of the produced bubbles.

20. The method according to claim 18, further comprising introducing gas into said liquid by means of at least one gasification unit, said at least one gasification unit comprising an annular microporous element that controls the size of the produced bubbles, and wherein multiple gasification units are positioned successively.

21. The method according to claim 18, further comprising introducing gas into said liquid by means of at least one gasification unit, said at least one gasification unit comprising an annular microporous element that controls the size of the produced bubbles, wherein multiple gasification units are positioned successively, and wherein pressure of the gas entering a first gasification unit and the annular microporous element of the first gasification unit produce bubbles that are different in size from the bubbles produced by an annular microporous element of a second gasification unit into which gas enters at a different pressure.

22. The method according to claim 18, wherein said gas is an inert gas selected from air, N₂, N₂O, CO₂, or any combination of these.

23. The method according to claim 18, wherein said gas provides pressure build-up and/or gasifies the liquid.

24. The method according to claim 18, wherein the pressure of the liquid after introducing gas in the access conduit and/or filler unit and/or exit conduit ranges from 1 to 10 bars.

25. The method according to claim 18, further comprising raising the pressure of the liquid by pumping the liquid prior to its entry into the filler unit.

26. The method according to claim 18, wherein the flexible walled containers are either open or closed to the atmosphere during filling.

27. The method according to claim 18, wherein the containers are provided at or below ambient temperature during and after filling.
